(19) United States
(12) Patent Application Publication
(10) Pub. No.: US 2006/0221783 A1
(43) Pub. Date: Oct. 5, 2006

(54) Optical head and optical disc apparatus

(76) Inventors: Kazuhiro Nagata, Yokohama-shi (JP); Katsuo Iwata, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/390,393

(22) Filed: Mar. 28, 2006

(30) Foreign Application Priority Data
Mar. 31, 2005 (JP) 2005-103746

(51) Int. Cl. G11B 7/00

(52) U.S. Cl. 369/44.28

(57) ABSTRACT

An embodiment of an optical head unit which is difficult to be influenced by an inter-layer crosstalk of recording layers and decreases a load of a signal reproduce system when reproducing and recording information from an optical disc having two or more recording layers, provide a diffraction optical element for focusing a pattern on the light-receiving surface of a photodetector which receives a reflected laser beam reflected on first and second recording layers of an optical disc and outputs a corresponding signal, in a state that a component close to the center of a reflected laser beam reflected by an optical disc is polarized. The diffraction optical element diffracts the central portion of a reflected laser beam at a fixed rate, receives a reflected laser beam reflected on the recording layer of an optical disc which passes a peripheral edge portion as a non-diffracted light.

### CROSS-REFERENCE TO RELATED APPLICATIONS

This application is based upon and claims the benefit of priority from Japanese Patent Application No. 2005-103746, filed Mar. 31, 2005, the entire contents of which are incorporated herein by reference.

### BACKGROUND

1. Field

One embodiment of the invention relates to an optical disc apparatus which records or reproduces information in/from an optical information recording medium or an optical disc, and an optical head unit incorporated in the optical disc apparatus.

2. Description of the Related Art

A long time has been passed since the commercialization of an optical disc capable of recording or reproducing information in a noncontact manner by using a laser beam, and an optical disc apparatus (an optical disc drive) which is capable of recording and reproducing information on/from an optical disc. Optical discs with several kinds of recording density called CD and DVD have become popular.

Recently, an ultra-high density optical disc (High Density [HD] DVD) using a laser beam with a blue or blue-purple wavelength to record information to increase the recording density, has been put to practical use.

It is inefficient from the view point of cost and installation place to prepare a separate optical disc apparatus (a disk drive) for each of various types of optical disc. An optical disc apparatus is required to be capable of recording, reproducing and erasing information on/from optical discs of more than one standard.

A laser beam with a wavelength of 780 nm for example is used for recording, reproducing and erasing information on/from a CD standard optical disc that is already very popular. The wavelength of a laser beam used for a DVD standard disc is 650 nm, for example. The wavelength of a laser beam used for recording, reproducing and erasing information on/from a HD-DVD standard disc is 400 to 410 nm.

An optical disc apparatus includes a light transmitting system to radiate a laser beam with a fixed wavelength to a specified position on an optical disc (a recording medium), a light receiving system to detect a laser beam reflected on an optical disc, a mechanism control (servo) system to control the operations of the light transmitting system and light receiving system, and a signal processing system which supplies recording information and an erase signal to the light transmitting system, and reproduces recorded information from a signal detected by the light receiving system.

The light transmitting system and light receiving system include a semiconductor laser element (laser diode), and an object lens which focuses a laser beam from a laser diode on the recording surface of an optical disc and captures a laser beam reflected by an optical disc. The position of an object lens is controlled by a control signal obtained by a signal processing system, so as to be located almost the center of the distance between a spot of a laser beam focused at the focal position of an object lens, optical disc and object lens, and to be guided at almost the center of a record mark string where a spot of a laser beam focused at the focal position of an object lens is recorded on an optical disc, or a previously formed guide groove or a track.

Since the wavelength of a laser beam used for recording, reproducing and erasing information on/from a HD-DVD standard optical disc is 400 to 410 nm, dividing an optical beam into areas by using a diffraction grating and focusing the optical beam in a photodetector, a (high-order) diffraction light not used as a detection light appears, an unnecessary light goes into a detector, or the diffraction efficiency of a necessary order component (optical beam) is lowered.

Further, a HD-DVD optical disc is low in the reflectivity on the recording/reproduce surface, and the S/N ration is lowered.

Japanese Patent Application Publication (KOKAI) No. 2004-39165 discloses a method of obtaining a good tracking error signal by dividing a reflected light from an optical information recording medium (optical disc) into a portion that a 0th-order light and ±1st-order diffraction light are overlapped and a portion that they are not overlapped, applying a reflected light to an independent optical detection means, and obtaining a designated signal.

However, in the unit disclosed by the above document, a diffraction angle of the ±1st-order diffraction light of the reflected light from the optical information recording medium is different depending on a wavelength of the reflected light, a track pitch of the optical information recording medium, etc.

Therefore, in an optical pickup unit which receives reflected light with more than one wavelength or a reflected light from track pitches of several types of optical information recording medium, it is impossible to uniquely determine a portion that a 0th-order light and ±1st-order diffraction light are overlapped and a portion that they are not overlapped.

Further, the above document does not include a method of ensuring the S/N ratio of a detection signal by using an optical beam with a wavelength of 400 to 410 nm.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram showing an example of an optical disc apparatus in accordance with an embodiment of the invention;

FIG. 2 is an exemplary diagram showing an example of a diffraction element incorporated in an optical head (PUH) of the optical disc apparatus shown in FIG. 1;

FIG. 3 is an exemplary diagram showing an example of using two light sources (2 wavelengths) in the optical disc apparatus shown in FIG. 1;

FIG. 4 is an exemplary diagram showing an example of using three light sources (3 wavelengths) in the optical disc apparatus shown in FIG. 1; and

FIGS. 5A and 5B are graphs explaining an exemplary film characteristic inverting band (wavelength characteristic) of a wavelength selection film used for an optical head (PUH) of the optical disc apparatus shown in FIG. 4.

### DETAILED DESCRIPTION

Various embodiments according to the invention will be described hereinafter with reference to the accompanying drawings. In general, according to one embodiment of the invention, an optical head unit which is difficult to be influenced by an inter-layer crosstalk of recording layers and decreases a load of a signal reproduce system when reproducing and recording information from an optical disc having two or more recording layers, provide a diffraction optical element for focusing a pattern on the light-receiving surface of a photodetector which receives a reflected laser beam reflected on first and second recording layers of an optical disc and outputs a corresponding signal, in a state that a component close to the center of a reflected laser beam reflected by an optical disc is polarized. The diffraction optical element diffracts the central portion of a reflected laser beam at a fixed rate, receives a reflected laser beam reflected on the recording layer of an optical disc which passes a peripheral edge portion as a non-diffracted light.

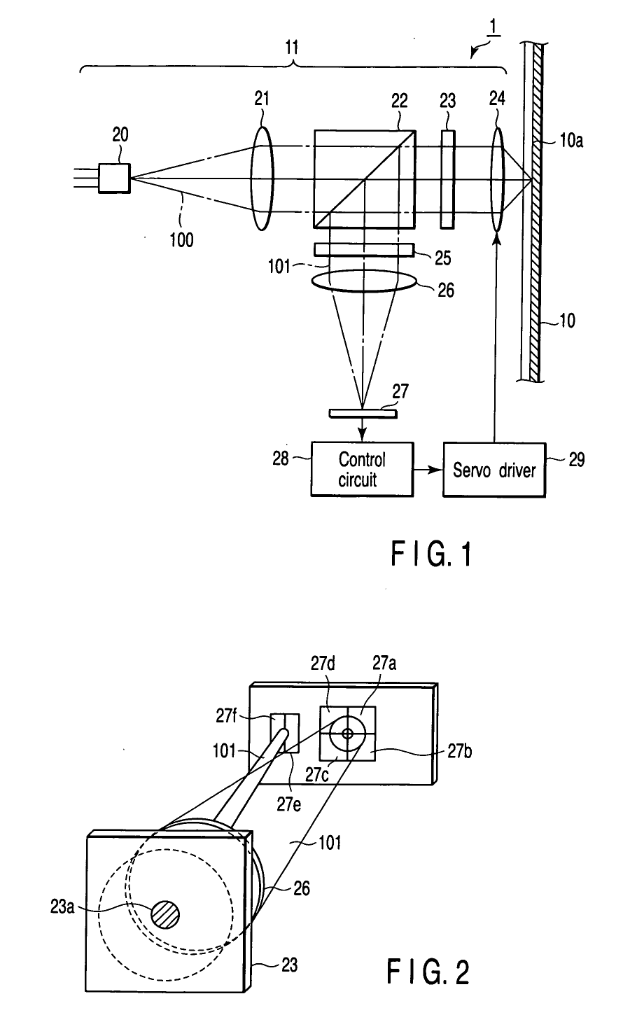

FIG. 1 shows an example of the configuration of an information recording/reproduce apparatus (an optical disc apparatus) to which the embodiments of the invention are applicable.

An optical disc apparatus 1 shown in FIG. 1 has an optical pickup (PUH) 11. The PUH 11 includes a semiconductor laser element (light source) 20 to output light with a fixed wavelength or a laser beam (optical beam). The wavelength of an optical beam emitted from the light source 20 is 400 to 410 nm, preferably 405 nm.

An optical beam 100 from the semiconductor laser element (light source) 20 is collimated by a collimator lens 21, passed through a λ/4 plate and a diffraction grating (HOE) 23, and guided to the recording/reproduce surface 10a of the optical disc 10 by an object lens 24.

The laser beam 100 focused on the recording/reproduce surface 10a of the optical disc 10 is reflected on the recording/reproduce surface, returned to the object lens 24 as a reflected laser beam 101, passed through the λ/4 plate and diffraction grating 23, and returned to a polarization beam splitter 22.

The reflected laser beam 101 returned to the polarization beam splitter 22 is reflected on the reflection surface 22a of the polarization beam splitter, given a fixed convergence through an aberration correction lens 25 and an image forming lens 26, and forms an image on the light-receiving surface of a photodetector 27.

The light-receiving surface of the photodetector 27 is usually divided into a predetermined form and predetermined number of areas, and outputs a current corresponding to the light intensity of the optical beam received by each light-receiving area. The current output from each light-receiving area of the photodetector 27 is converted into a voltage by a not-shown I/V (current-voltage) conversion amplifier, and processed by a control circuit 28 to be usable for a RF (Radio Frequency) signal, a focus error signal and a tracking error signal. The radio frequency (RF) signal is outputted to a temporary storage or an external storage, for example, in being converted into a specified signal format not described in detail, or through a specified interface. The signal obtained by the control circuit 28 is supplied also to a servo driver 29 and used to generate a focus error signal for changing the position of the object lens 24, so that an optical spot formed in a specified size at the focal position of the object lens 24 becomes identical to the distance between the object lens 24 and the recording/reproduce surface 10a of the optical disc 10. The focus error signal is used to obtain a focus control signal for changing the position of a not-shown actuator which displaces the position of the object lens 24. The focus control signal generated based on the focus error signal is supplied to the actuator. Thus, the object lens 24 held by the actuator is optionally moved in the direction close to or separated away from the recording/reproduce surface 10a of the optical disc 10 (in the lateral direction in FIG. 1).

The signal obtained by the control circuit 28 is also supplied to a servo driver 29, and used to generate a tracking error signal for changing the position of the object lens 24, so that an optical spot of the optical beam 100 focused at the focal position of the object lens 24 is guided at substantially the center of a record mark string recorded on the recording/reproduce surface 10a of the optical disc 10, or a previously formed guide groove or a track. The tracking error signal is used to obtain a tracking control signal for changing the position of a not-shown actuator which displaces the position of the object lens 24, to a specified position. The tracking control signal generated based on the tracking error signal is supplied to the actuator. Therefore, the object lens 24 held by the actuator is optionally moved in the direction crossing the radial direction of the recording/reproduce surface 10a of the optical disc 10 or a track or a record mark string.

Namely, the object lens 24 is sequentially controlled by the servo driver 29, so that the size of the optical spot focused on the track or record mark string formed on the recording/reproduce surface 10a of the optical disc 10 by the object lens 24 becomes smallest in its focal distance.

FIG. 2 explains the function of a diffraction element (HOE) used in an optical head unit (PUH) of the optical disc apparatus shown in FIG. 1. In FIG. 2, the polarization beam splitter and aberration correction lens are eliminated from the optical head unit of the optical disc apparatus shown in FIG. 1 for simplification of explanation.

The diffraction element 23 is configured by forming a polarization-dependent diffraction grating pattern in one body with a know λ/4 plate on its one side by a hologram, for example, and acts mainly on a reflected optical beam reflected on the recording/reproduce surface 10a of the optical disc 10.

The diffraction element 23 has at almost the center a diffraction pattern 23a used for manly generating a tracking error signal.

The remaining area of the diffraction element except the diffraction pattern 23a is given an optical characteristic substantially equivalent to a parallel flat plate, for example. Namely, the peripheral part of the diffraction element 23 is given only the function as a λ/plate. The diffraction element 23 is a liquid crystal element usable for correcting aberration, for example, (variable in the thickness or refractive index), and may have a diffraction pattern 23a at the center.

Namely, in the diffraction element 23, the area passing an optical beam is divided into two areas: a first area (diffraction pattern) 23a given a diffraction component, and a second area passing an optical beam substantially as it were. A RF (Radio Frequency) signal requiring a light intensity and an optical beam (101) used for detection of a focus error and a tracking error are passed through the second area without giving a diffraction component, and only an optical beam used for compensation of a track servo signal is passed through the first area 23a having a diffraction groove (hologram diffraction pattern). Thereby, the amount of light of an optical beam for the RF signal (the amount of light except an optical beam used for compensation of a track servo signal), out of those focused by the photodetector 27, can be ensured.

In this case, it is also controlled (decreased) that a high-order component by diffraction (a diffracted optical beam) is guided to detection areas 27 to 27d for the RF signal of the photodetector 27 (including the one for detection of a focus error and a tracking error). Thus, a fluctuation of the intensity of an optical beam is controlled, and the level of a detection signal is stabilized. The use efficiency of an optical beam used for detection of the RF signal (including detection of a focus error and a tracking error) is increased.

An optical beam (diffracted light) used for compensation of a track servo signal is guided to detection areas 27e and 27f placed at a fixed distance from the detection areas 27a to 27d of the photodetector 27. Therefore, a diffracted light that can be a noise component is prevented from entering the detection areas 27a to 27d, and the signal-to-noise ratio is improved.

A first area to occupy the area of the λ/4 plate and HOE 23 or an area to form a diffraction pattern 23a is preferably in a range of 30 to 50%, for example, of a sectional spot size (area) of a radiated optical beam, in order to ensure compensation of a track servo signal while keeping the intensity of RF signal.

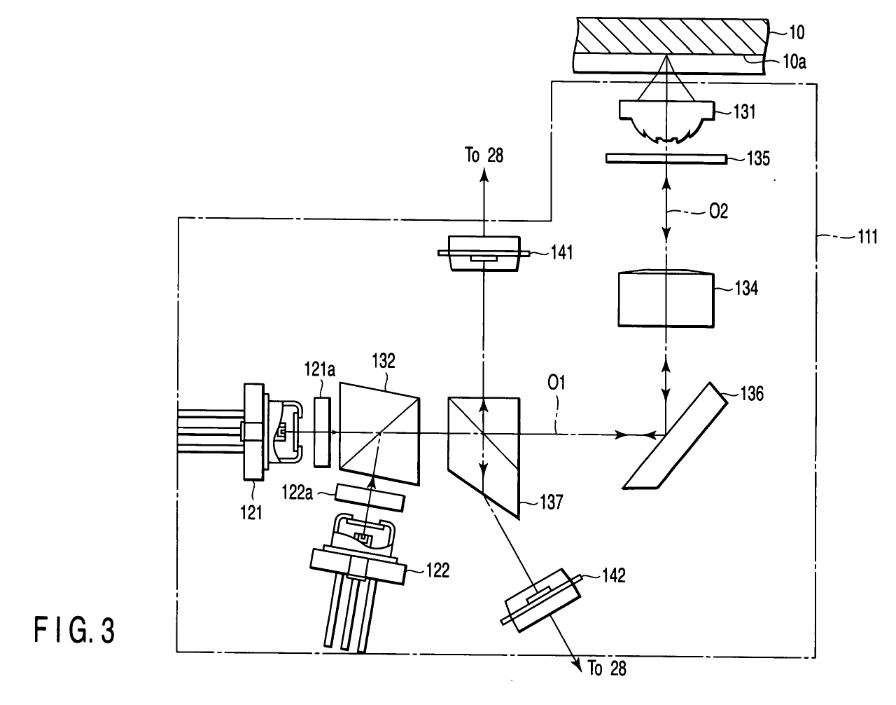

FIG. 3 shows another embodiment of the optical disc apparatus shown in FIG. 1 and a PUH (optical head) incorporated in the optical disc apparatus.

The optical disc apparatus shown in FIG. 3 enables an optical head or PUH 111 to output two optical beams with different wavelengths, and includes a first semiconductor laser element (first light source) 121 to emit a laser beam with a first wavelength, and a second semiconductor laser element (second light source) 122 to emit a laser beam with a second wavelength longer than the first wavelength. The wavelength of a laser beam outputted from the first light source 121 is 400 to 410, preferably 405 nm, for example. The wavelength of a laser beam output from the second light source 122 is preferably 650 nm.

The first and second light sources 121 and 122 are provided with λ/2 plates 121a and 122a for adjusting the polarizing direction of an emitted laser beam (for changing the ratio of P-polarization to S-polarization to a specified ratio), in the vicinity thereto (or in one body therewith).

An object lens 131 is provided at a specified position in the PUH 111 opposite to the optical disc 10. The object lens 131 is a 2-wavelength applicable lens capable of providing a specified numerical aperture (NA) for each laser beam output from the first and second laser elements 121 and 122. The object lens 131 is made of plastic, and has a numerical aperture (NA) of 0.65 for a laser beam with a wavelength of 405 nm, and 0.6 for a laser beam with a wavelength of 650 nm, for example.

Optical beams outputted from the first and second light sources 121 and 122 are overlapped in the optical paths by a coupling prism 132, passed through a beam splitter 137 placed on an optical axis 01, collimated by a collimator lens 134, passed through a λ/4 plate and diffraction element 135, and guided to the object lens 131. Usually, in designing an optical path or for decreasing the thickness of the PUH 111, a mirror 136 to bend the optical path (usually called a rising mirror) is provided between the collimator lens 134 and diffraction element (λ/4 plate) 135 or between the collimator lens 134 and beam splitter 137 (equivalent to the example shown in FIG. 3), and an optical axis 02 substantially orthogonal to the optical axis 01 is provided.

In the direction that the reflected laser beam reflected by the beam splitter 137 advances, there is provided a photodetector 141 which detects a reflected laser beam reflected on the recording/reproduce surface 10a of the optical disc 10, and outputs an electric signal corresponding to the light intensity of the laser beam. The beam splitter 137 is a polarization beam splitter with an optical thin film set to pass a P-polarization light, and (therefore) reflects a S-polarization light, which can separate the S-polarization component of a reflected laser beam from a laser beam advancing the optical disc 10, by reflecting the S-polarization component on the optical thin film (in this example).

A photodetector 142 for auto poser control (APC) (hereinafter called an APC detector) is provided at a specified position, so that the beam splitter 137 can detect a laser beam (S-polarization) separated from a laser beam (P-polarization) advancing from a respective light source to the optical disc 10.

The coupling prism (dichroic prism) 132 passes a laser beam with a wavelength of 405 nm (400 to 410 nm) emitted from a semiconductor laser element 121 for the first light source, that is, HD DVD, and reflects a laser beam with a wavelength of 650 nm (645 to 660 nm) emitted from a semiconductor laser element 122 for the second light source, that is, DVD, thereby overlapping the laser beams on the same optical path.

Of course, the λ/4 plate and diffraction element 135 in the PUH 111 shown in FIG. 3 has substantially the same function as the diffraction element 23 explained before in FIG. 2.

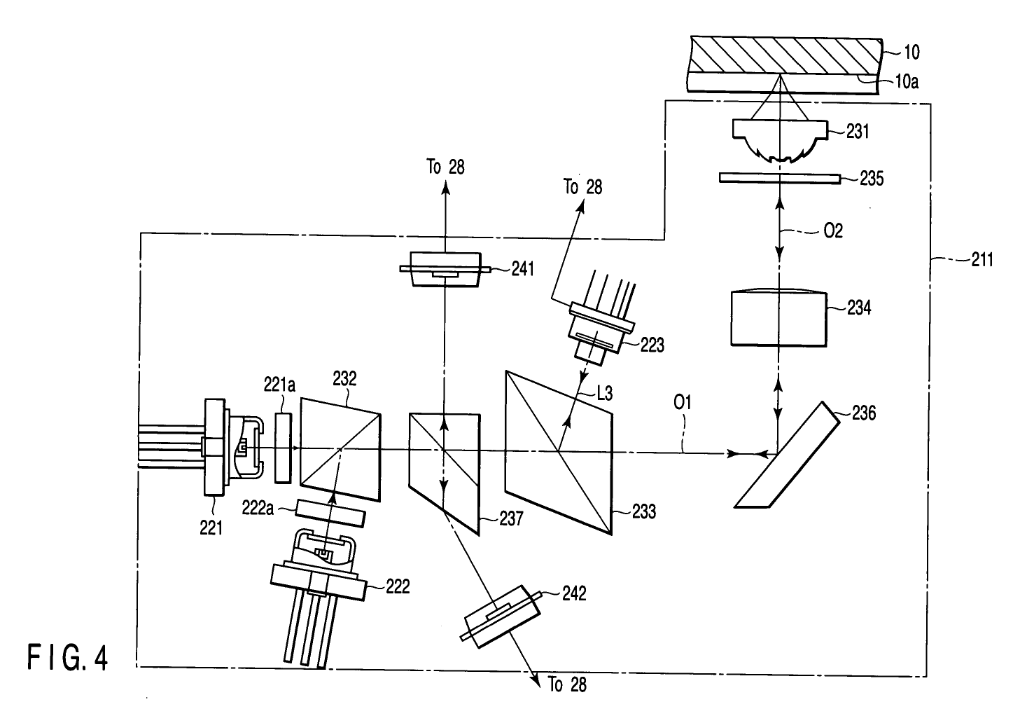

FIG. 4 shows a still another embodiment of the optical disc apparatus shown in FIG. 1 and a PUH (optical head) incorporated in the optical disc apparatus.

The optical disc apparatus shown in FIG. 4 enables an optical head or PUH 211 to output three optical beams with different wavelengths, and includes a first semiconductor laser element (first light source) 221 to emit a laser beam with a first wavelength, a second semiconductor laser element (second light source) 222 to emit a laser beam with a second wavelength longer than the first wavelength, and a third semiconductor laser element (second light source) 223 to emit a laser beam with a third wavelength longer than the second wavelength. The wavelength of a laser beam output from the first light source 221 is 400 to 410, preferably 405 nm, for example. The wavelength of a laser beam output from the second light source 222 is preferably 650 nm. The wavelength of a laser beam outputted from the third light source 223 is preferably 780 nm.

The first and second light sources 221 and 222 are provided with λ/2 plates 221a and 222a for adjusting the polarizing direction of an emitted laser beam (for changing the ratio of P-polarization to S-polarization to a specified ratio), in the vicinity thereto (or in one body therewith). A λ/2 plate is not used for an optical beam with a wavelength of 780 nm from the third light source 223. A wavelength selection film of the second coupling prism 233 is optimized.

An object lens 231 is provided at a specified position in the PUH 211 opposite to the optical disc 10. The object lens 231 is a 3-wavelength applicable lens capable of providing a specified numerical aperture (NA) for each laser beam outputted from the first, second and third laser elements 221, 222 and 223. The object lens 231 is made of plastic, and has a numerical aperture NA of 0.65 for a laser beam with a wavelength of 405 nm, 0.6 for a laser beam with a wavelength of 650 nm, and 0.45 to 0.5 for a laser beam with a wavelength of 780 nm, for example.

Optical beams output from the first and second light sources 221 and 222 are overlapped in the optical paths by a coupling prism 232, passed through a beam splitter 237 placed on an optical axis 01, collimated by a collimator lens 234, passed through a λ/4 plate and diffraction element 235, and guided to the object lens 231. Usually, in designing an optical path or for decreasing the thickness of the PUH 211, a mirror 236 to bend the optical path (usually called a rising mirror) is provided between the collimator lens 234 and diffraction element (λ/4 plate) 235 or between the collimator lens 134 and beam splitter 237 (equivalent to the example shown in FIG. 4), and an optical axis 02 substantially orthogonal to the optical axis 01 is provided.

In the direction that the reflected laser beam reflected by the beam splitter 237 advances, there is provided a photodetector 241 which detects a reflected laser beam reflected on the recording/reproduce surface 10a of the optical disc 10, and outputs an electric signal corresponding to the light intensity of the laser beam. The beam splitter 237 is a polarization beam splitter with an optical thin film set to pass a P-polarization light, and (therefore) reflects a S-polarization light, which can separate the S-polarization component of a reflected laser beam from a laser beam advancing the optical disc 10, by reflecting the S-polarization component on the optical thin film (in this example).

A photodetector 242 for auto poser control (APC) (hereinafter called an APC detector) is provided at a specified position, so that the beam splitter 237 can detect a laser beam (S-polarization) separated from a laser beam (P-polarization) advancing from a respective light source to the optical disc 10.

The coupling prism (dichroic prism) 232 passes a laser beam with a wavelength of 405 nm (400 to 410 nm) emitted from a semiconductor laser element 221 for the first light source, that is, HD DVD, and reflects a laser beam with a wavelength of 650 nm (645 to 660 nm) emitted from a semiconductor laser element 222 for the second light source, that is, DVD, thereby overlapping the laser beams on the same optical path.

The coupling prism (trichroic prism) 233 passes a laser beam with a wavelength of 405 nm (400 to 410 nm) emitted from a semiconductor laser element 221 for the first light source, that is, HD DVD, and reflects a laser beam with a wavelength of 650 nm (645 to 660 nm) emitted from a semiconductor laser element 222 for the second light source, that is, DVD, and reflects a laser beam with a wavelength of 780 nm (770 to 790 nm), thereby overlapping the laser beams on the same optical path. The coupling prism (trichroic prism) 233 has a wavelength selection characteristic to reflect also a reflected laser beam that is reflected on the recording/reproduce surface 10a of the optical disc 10.

Of course, the λ/4 plate and diffraction element 235 in the PUH 211 shown in FIG. 4 has substantially the same function as the diffraction element 23 explained before in FIG. 2.

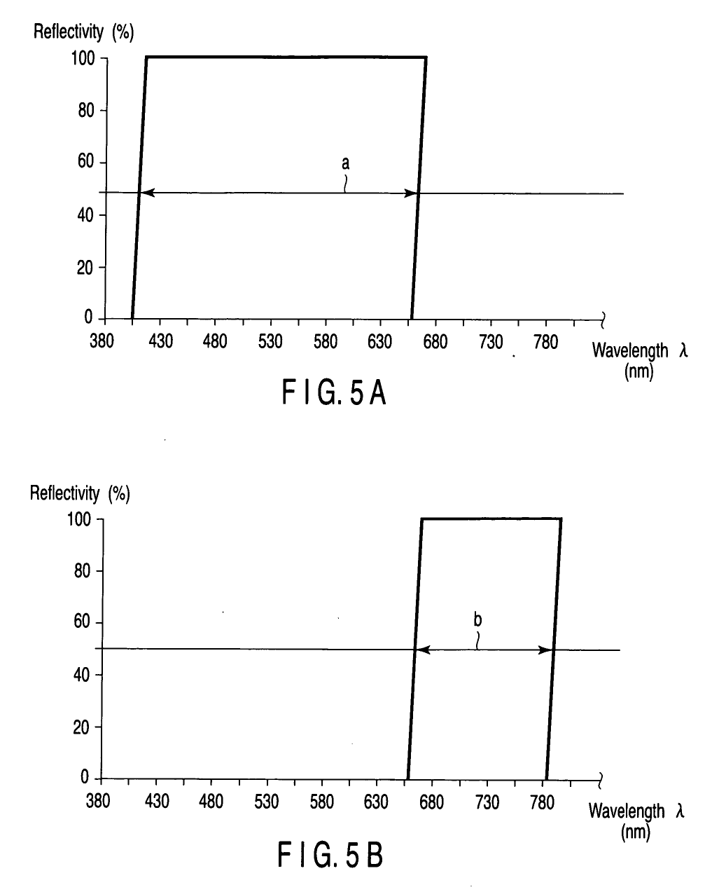

FIG. 5A explains a wavelength selection characteristic (film characteristic inverting wavelength band) required for the coupling prism (dichroic mirror) 231, λ/4 plate and HOE (diffraction element) 235 used in the PUH 211 shown in FIG. 4. FIG. 5B explains a wavelength selection characteristic

(film characteristic inverting wavelength band)

required for the coupling prism (trichroic mirror) 233 used in the PUH 211 shown in FIG. 4.

The film characteristic inverting wavelength band indicated by a band [a] in FIG. 5A is preferably defined to 400 to 660 nm (reflects all laser beams with wavelengths longer than 660 nm and shorter than 400 nm). The film characteristic inverting wavelength band indicated by a band [b] in FIG. 5B is preferably defined to 660 to 790 nm (reflects all laser beams with wavelengths longer than 790 nm).

As explained hereinbefore, the optical head unit and optical disc apparatus of this invention are characterized by providing a diffraction groove only in an area passing an optical beam used for compensation of a servo signal, among areas passing optical beams of a diffraction grating, and using a structure such as a parallel flat plate with a high transmissivity or liquid crystal elements usable for aberration correction in the other areas.

This decreases the cause of a diffraction efficiency error in a process of manufacturing a diffraction element (grating), and realizes a stable and efficient optical system (signal detection system).

Therefore, an optical head unit and optical disc apparatus with high stability and reliability can be obtained.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

But, an embodiment of the invention is applicable widely for an optical head for information recording media having a light-transmitting layer. As information recording media to be recorded and played back, a read only optical disc, optical magnetic disc and optical card may be used.

What is claimed is:

1. an optical head unit comprising:
an object lens which captures light reflected on the recording/reproduce surface of a recording medium;
a diffraction element which is provided on an optical path toward the object lens, and has a diffraction pattern to give a fixed diffraction characteristic, in a part of the light reflected on the recording/reproduce surface;
a first photodetector which detects light given a fixed diffraction characteristic by the diffraction pattern of the diffraction element, and outputs a first signal;
a second photodetector which detects light passing through an area different from the diffraction pattern of the diffraction element, and outputs a second signal; and
a signal processing unit which generates a component to compensate an offset of the object lens in the radial direction on the recording/reproduce surface based on the output of the first photodetector, and generates a component to correct the position of the object lens in the radial direction on the recording/reproduce surface and to correct the distance of the object lens to the recording/reproduce surface based on the output of the second photodetector.

2. The optical head unit according to claim 1, wherein the diffraction pattern of the diffraction element acts on the center of an optical beam entering the diffraction element.

3. The optical head unit according to claim 1, wherein a parallel flat plate is used in areas different from the diffraction pattern of the diffraction element.

4. The optical head unit according to claim 1, wherein a liquid crystal element with a controllable thickness or refractive index is used in areas different from the diffraction pattern of the diffraction element.

5. The optical head unit according to claim 1, wherein the output of the second photodetector is used for reproducing information recorded on the recording/reproduce surface of the recording medium.

6. The optical head unit according to claim 2, wherein the output of the second photodetector is used for reproducing information recorded on the recording/reproduce surface of the recording medium.

7. The optical head unit according to claim 3, wherein the output of the second photodetector is used for reproducing information recorded on the recording/reproduce surface of the recording medium.

8. The optical head unit according to claim 4, wherein the output of the second photodetector is used for reproducing information recorded on the recording/reproduce surface of the recording medium.

9. An optical head unit comprising:
a first light source which outputs light with a first wavelength;
a second light source which outputs light with a second wavelength different from the wavelength of the light from the first light source;
an object lens which focuses light outputted from the first and second light sources and overlapped in an optical path on the recording/reproduce surface of a recording medium, and captures light reflected on the recording/reproduce surface of a recording medium;
a diffraction element which is provided on an optical path toward the object lens, and has a diffraction pattern to give a fixed diffraction characteristic, in a part of the light reflected on the recording/reproduce surface;
a first photodetector which detects light given a fixed diffraction characteristic by the diffraction pattern of the diffraction element, and outputs a first signal;
a second photodetector which detects light passing through an area different from the diffraction pattern of the diffraction element, and outputs a second signal; and
a signal processing unit which generates a component to compensate an offset of the object lens in the radial direction on the recording/reproduce surface based on the output of the first photodetector, and generates a component to correct the position of the object lens in the radial direction on the recording/reproduce surface and to correct the distance of the object lens to the recording/reproduce surface based on the output of the second photodetector.

10. The optical head unit according to claim 9, wherein the diffraction pattern of the diffraction element acts on the center of an optical beam entering the diffraction element.

11. The optical head unit according to claim 9, wherein a parallel flat plate is used in areas different from the diffraction pattern of the diffraction element.

12. The optical head unit according to claim 9, wherein a liquid crystal element with a controllable thickness or refractive index is used in areas different from the diffraction pattern of the diffraction element.

13. An optical disc apparatus comprising:
an optical head unit having a first light source which outputs light with a first wavelength; a second light source which outputs light with a second wavelength different from the wavelength of the light from the first light source; an object lens which focuses light outputted from the first and second light sources and overlapped in an optical path on the recording/reproduce surface of a recording medium, and captures light reflected on the recording/reproduce surface of a recording medium; a diffraction element which is provided on an optical path toward the object lens, and has a diffraction pattern to give a fixed diffraction characteristic, in a part of the light reflected on the recording/reproduce surface; a first photodetector which detects light given a fixed diffraction characteristic by the diffraction pattern of the diffraction element, and outputs a first signal; a second photodetector which detects light passing through an area different from the diffraction pattern of the diffraction element, and outputs a second signal; and a signal processing unit which generates a component to compensate an offset of the object lens in the radial direction on the recording/reproduce surface based on the output of the first photodetector, and generates a component to correct the position of the object lens in the radial direction on the recording/reproduce surface and to correct the distance of the object lens to the recording/reproduce surface based on the output of the second photodetector; and
a recorded information reproduce unit which reproduces information recorded on the recording/reproduce surface of the recording medium from an output of the second photodetector.
